(19) United States
(12) Patent Application Publication
(10) Pub. No.: US 2015/0005418 A1
(43) Pub. Date: Jan. 1, 2015

(54) COLOURED TYRE PORTIONS

(71) Applicant: BRIDGESTONE CORPORATION, Chuo-ku, Tokyo (JP)

(72) Inventors: Paolo Fiorenza, Roma (IT); Gianluca Forte, Roma (IT)

(73) Assignee: BRIDGESTONE CORPORATION, Chuo-ku, Tokyo (JP)

(21) Appl. No.: 14/366,536

(22) PCT Filed: Dec. 24, 2012
(86) PCT No.: PCT/IB2012/057692

§ 371 Date: Jun. 18, 2014

(30) Foreign Application Priority Data
Dec. 23, 2011 (IT) TO2011A001207

(51) Int. Cl. B60C 13/04; B60C 13/00

(52) U.S. Cl. CPC B60C 13/04; B60C 13/001
USPC 524/110

(57) ABSTRACT

A coloured tyre portion having a polymer base with added pigments for producing the desired colour, and an added optical whitener. Alternatively, the optical whitener is added to a dye deposited on a highly impermeable barrier layer, in turn deposited on the part of the tyre for colouring.

### CROSS REFERENCE TO RELATED APPLICATIONS

This is a National Stage of International Application No. PCT/IB2012/057692 filed Dec. 24, 2012, claiming priority based on Italian Patent Application No. TO2011A001207 filed Dec. 23, 2011, the contents of all of which are incorporated herein by reference in their entirety.

### TECHNICAL FIELD

The present invention relates to coloured tyre portions.

Hereinafter, the term ‘optical whitener’ refers to a substance which absorbs part of the incident radiation in the invisible ultraviolet region, and reflects it at longer wavelengths in the upper part of the visible spectrum, thus making the reflected spectrum bluer and therefore seemingly whiter.

### BACKGROUND ART

In recent years, demand has increased for coloured tyre portions, particularly sidewalls, for various, not least of all, aesthetic reasons.

Current technology is based on using coloured rubber compounds produced using appropriate pigments.

The coloured rubber is connected to the black rubber of the tyre at the tyre building stage.

A drawback of this technology lies in fast fading of the coloured portion, mainly due to chemical agents, such as antioxidants, migrating from the inner tyre layers to the coloured compound.

Another recently adopted solution is to insert between the tyre shoulder and the coloured layer a barrier layer made from a composition designed to minimize migration of the chemical agents. The Applicant has devised a method of producing coloured tyre portions, wherein a polymer barrier layer, formed by drying an aqueous dispersion, is deposited on the part of the tyre for colouring. This method is described in Patent Applications TO2009A000964 and TO2010A000850 included herein by way of reference.

Even with the barrier layer, however, in high-temperature operating conditions or after long use, the chemical agents still manage to get through the barrier layer to the coloured layer, thus resulting in fading.

White coloured portions, often on the sidewalls of the tyre, pose the most serious fading problem.

A need is therefore felt for a method of forming coloured tyre portions, which guarantees colour fastness regardless of the operating conditions and working life of the tyre.

The Applicant has discovered that fading of the coloured portion is mainly due to the chemical agents from the underlying portions interacting with the UV radiation impinging on them.

### DISCLOSURE OF INVENTION

One object of the present invention is a coloured tyre portion comprising a highly impermeable barrier layer on the part of the tyre for colouring; and a dye on said barrier layer; said coloured portion being characterized in that said dye comprises an optical whitener.

Preferably, said optical whitener is in a class selected from the group consisting of triazine trans-stilbene, coumarins, imidazolines, diazoles, triazoles, benzoxazolines, and biphenyl trans-stilbene. Preferably, said dye is a water-based dye, a polyurethane dye, or a photo-cross-linkable dye when subjected to UV radiation.

Preferably, the barrier layer is formed by drying an aqueous dispersion.

Preferably, the barrier layer aqueous dispersion comprises at least one cross-linkable polymer base and a surfactant of molecular formula (I)

(R₁CONR₂CHR₃COO⁻)nXⁿ⁺ (I)

where:

R₁ is an aliphatic group C₆-C₂₃

R₂ is H or an aliphatic group C₁-C₈

R₃ is H or an aliphatic or aromatic group C₁-C₈

X is a metallic cation, preferably an alkaline cation, and

n is an integer from 1 to 3.

Preferably, the aliphatic group R₁ comprises a double bond.

Preferably, the barrier layer aqueous dispersion comprises at least one cross-linkable polymer base and a surfactant of molecular formula (II)

([R₄R₅R₆NR₈(NR₇R₉R₁₀)n]⁽ⁿ⁺¹⁾⁺)y(n+1)X^{y-} (II)

where:

X is an atom or an anionic group

R₄, R₅ and R₆, which are the same or different, are each CₘH₂ₘ₊₁, where m is 1 to 3, or CH₂CHCH₂ or CHCHCH₃

R₇, R₉ e R₁₀, which are the same or different, are each CH₂CHCH₂ or CHCHCH₃

n is 0 or 1

y is 1, if n is 1; y is 1 or 2, if n is 0

R₈ is an aliphatic group C₁₅-C₂₂ when n is 0, and is an aliphatic group C₈-C₁₆ when n is 1

when n is 0, at least one of R₄, R₅, R₆ and R₈ comprises a double bond.

Preferably, R₇, R₈ and R₉ are CH₂CHCH₂, and, more preferably, n is 1 and R₈ is a saturated aliphatic group.

Preferably, R₈ comprises a double bond, and n is 0.

Another object of the present invention is a tyre comprising a coloured portion in accordance with the present invention.

Another object of the present invention is use of an optical whitener in a dye that can be applied to a tyre portion.

### BEST MODE FOR CARRYING OUT THE INVENTION

The following are non-limiting examples for a clearer understanding of the present invention.

### Examples

Below, two examples (EXAMPLES A) are described to show the effectiveness of the optical whitener on a layer of coloured rubber comprising antioxidants and subjected to UV radiation.

EXAMPLES B relate to coloured portions.

EXAMPLES C relate to coloured portions according to the solution of the present invention, and a relative control example.

### Examples A

Two layers of coloured rubber were formed from respective compounds with the compositions, in phr, shown in Table I.

TABLE I

| | A1 | A2 |
|---|---|---|
| NR | 40 | 40 |
| Cl-IIR | 40 | 40 |
| EPDM | 20 | 20 |
| TiO₂ | 60 | 60 |
| Sulphur | 0.75 | 0.75 |
| MBTS | 1.0 | 1.0 |
| ZnO | 7.0 | 7.0 |
| Stearic acid | 1.0 | 1.0 |
| 6PPD | 0.5 | 0.5 |
| Umbelliferone | 30 | — |
| ΔE | 81.6 | 100 |

NR stands for natural rubber; Cl-IIR for chlorine-butyl rubber; and EPDM for ethylene-propylene-diene.

As shown by the compositions in Table I, compounds A1 and A2 differ solely as to the presence or absence of the optical whitener (Umbelliferone), i.e. only compound A1 features the technical solution according to the present invention.

The rubber layers made from the two compounds were exposed to UV radiation (366 nm) for seven consecutive days, after which, fading was determined using a fade index as established at the 1976 International Commission on Illumination. The fade index ΔE is defined by the formula:

ΔE=[(ΔL)²+(Δa)²+(Δb)²]^{1/2}

where:

L is luminosity; a is red-green light sensation; and b is yellow-blue light sensation. More specifically, fading was measured using a Minolta CM 2002 spectrophotometer.

The fade indexes in the last line of Table I are indexed to the control compound A2 layer result.

The results show how the presence of compounds such as antioxidants (6PPD) in the coloured rubber causes fading when exposed to UV radiation, and how fading is counteracted visually by the simultaneous presence of an optical whitener.

### Examples B

Three coloured rubber layers were formed from respective compounds with the compositions, in phr, shown in Table II.

TABLE II

| | B1 | B2 | B3 |
|---|---|---|---|
| NR | 40 | 40 | 40 |
| Cl-IIR | 40 | 40 | 40 |
| EPDM | 20 | 20 | 20 |
| TiO₂ | 60 | 60 | 60 |
| Sulphur | 0.75 | 0.75 | 0.75 |
| MBTS | 1.0 | 1.0 | 1.0 |
| ZnO | 7.0 | 7.0 | 7.0 |
| Stearic acid | 1 | 1 | 1 |
| 1Cumarin | 30 | — | — |
| Umbelliferone | — | 30 | — |
| ΔE | 84.0 | 65.0 | 100 |

Compositions B1 and B2 comprising an optical whitener (Umbelliferone or 1 Cumarin) represent compounds in accordance with a first solution of the invention, and compound B3 represents a specific control compound.

Three coloured portions were made from compounds B1-B3 and connected to conventional black compounds used to form tyre sidewalls and comprising 1.5 phr of antioxidant 6 PPD.

Coloured portions B1-B3, each made by connecting a respective coloured compound B1-B3 to a conventional tyre sidewall compound, were aged thermally to cause migration of the antioxidants in the coloured compound portion. More specifically, coloured portions B1-B3 were kept at a temperature of 70° C. for 6 days.

The aged portions were then exposed to UV radiation (366 nm) for 7 days.

Following exposure, the fade indexes were determined as described above.

The fade indexes in the last line of Table II are indexed to that of the control compound B3 layer.

As shown clearly, the layer made from control compound B3 shows much greater fading than the coloured layers formed in accordance with the present invention. More specifically, the layer made from the compound comprising Umbelliferone shows far less fading than the control compound layer.

### Examples C

Preparation of Barrier Layers Ca and Cb

Coloured tyre portions were formed using the method according to the present invention.

The barrier layers used were formed by drying respective aqueous dispersions. By way of example, the dispersions were made by dispersing all the Table I ingredients simultaneously in 1 litre of water. The resulting aqueous dispersion was stirred mechanically for 30 minutes and then sonicated for 15 minutes.

The compositions, in phr, of the two barrier layers formed by drying respective aqueous dispersions are shown in Table III.

TABLE III

| | Ca | Cb |
|---|---|---|
| Cl-IIR | 100 | 100 |
| CARBON BLACK | 50 | 50 |
| RESIN | 10 | 10 |
| ZnO | 1.5 | 1.5 |
| SULPHUR | 2.8 | 2.8 |
| ACCELERANTS | 1.5 | 1.5 |
| SURFACTANT (a) | 2.0 | — |
| SURFACTANT (b) | — | 2.0 |

Surfactant (a) is of molecular formula CH₃(CH₂)₇CHCH(CH₂)₇CONHCH₂COO⁻Na⁺; and surfactant (b) is of molecular formula [(CH₃)₃N(CH₂)₈CHCH(CH₂)₇CH₃]⁺I⁻.

The aqueous dispersion was deposited on the shoulder portion for colouring, and was dried to form the barrier layer.

Preparation of Coloured Portions Ca1, Cb1, Ca2 and Cb2

A water-based white dye was applied to each of the barrier layers formed as described above. More specifically, the water-based dye is one of a group of paints known as ‘VERNICI IMC IDRO’ produced and marketed by SIVAM VERNICI SPA.

To form coloured portions Ca1 and Cb1, a 30% by dry weight concentration of Umbelliferone was added to the water-based dye as an optical whitener, whereas, to form coloured portions Ca2 and Cb2, the water-based dye was used as it is, i.e. with no added optical whitener. Coloured portions Ca2 and Cb2 thus constitute two control examples.

As described for portions B1-B3, coloured portions Ca1, Cb1, Ca2 and Cb2 were aged thermally to cause migration of the antioxidants in the coloured compound portion, and were then exposed to UV radiation (366 nm) for 7 days.

Following exposure, the fade indexes were determined as described above.

In Table IV, the fade indexes of coloured portions Ca1 and Cb1 are indexed to those of respective control examples Ca2 and Cb2.

TABLE IV

| | Ca1 | Ca2 | Cb1 | Cb2 |
|---|---|---|---|---|
| ΔE | 74 | 100 | 78 | 100 |

As shown clearly in Table IV, coloured portions Ca1 and Cb1 show much less noticeable fading than respective control examples Ca2 and Cb2.

1-13. (canceled)

14. A coloured tyre portion comprising a highly impermeable barrier layer on the part of the tyre for colouring; and a dye on said barrier layer; said coloured portion being characterized in that said dye comprises an optical whitener.

15. A coloured tyre portion as claimed in claim 14, characterized in that said optical whitener is in a class selected from the group consisting of triazine trans-stilbene, coumarins, imidazolines, diazoles, triazoles, benzoxazolines, and biphenyl trans-stilbene.

16. A coloured tyre portion as claimed in claim 14, characterized in that said dye is a water-based dye, a polyurethane dye, or a photo-cross-linkable dye when subjected to UV radiation.

17. A coloured tyre portion as claimed in claim 16, characterized in that the barrier layer is formed by drying an aqueous dispersion.

18. A coloured tyre portion as claimed in claim 17, characterized in that the barrier layer aqueous dispersion comprises at least one cross-linkable polymer base and a surfactant of molecular formula (I)
(R₁CONR₂CHR₃COO⁻)nXⁿ⁺ (I)
where:
R₁ is an aliphatic group C₆-C₂₃
R₂ is H or an aliphatic group C₁-C₈
R₃ is H or an aliphatic or aromatic group C₁-C₈
X is a metallic cation, preferably an alkaline cation, and
n is an integer from 1 to 3.

19. A coloured tyre portion as claimed in claim 18, characterized in that the aliphatic group R₁ comprises a double bond.

20. A coloured tyre portion as claimed in claim 17, characterized in that the barrier layer aqueous dispersion comprises at least one cross-linkable polymer base and a surfactant of molecular formula (II)
([R₄R₅R₆NR₈(NR₇R₉R₁₀)n]⁽ⁿ⁺¹⁾⁺)y(n+1)X^{y-} (II)
where:
X is an atom or an anionic group
R₄, R₅ and R₆, which are the same or different, are each CₘH₂ₘ₊₁, where m is 1 to 3, or CH₂CHCH₂ or CHCHCH₃
R₇, R₉ e R₁₀, which are the same or different, are each CH₂CHCH₂ or CHCHCH₃
n is 0 or 1
y is 1, if n is 1; y is 1 or 2, if n is 0
R₈ is an aliphatic group C₁₅-C₂₂ when n is 0, and is an aliphatic group C₈-C₁₆ when n is 1
when n is 0, at least one of R₄, R₅, R₆ and R₈ comprises a double bond.

21. A coloured tyre portion as claimed in claim 20, characterized in that R₇, R₈ and R₉ are CH₂CHCH₂.

22. A coloured tyre portion as claimed in claim 20, characterized in that n is 1 and R₈ is a saturated aliphatic group.

23. A tyre comprising a coloured portion as claimed in claim 14.

24. Use of an optical whitener in a dye that can be applied to a tyre portion.
